(19) United States
(12) Patent Application Publication
(10) Pub. No.: US 2007/0011133 A1
(43) Pub. Date: Jan. 11, 2007

(54) Voice search engine generating sub-topics based on recognitiion confidence

(75) Inventor: Hisao M. Chang, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/158,927

(22) Filed: Jun. 22, 2005

(51) Int. Cl. G06F 17/30

(52) U.S. Cl. 707/1

(57) ABSTRACT

A first utterance of words made by a user is received. A first at least one word in the first utterance is recognized with high confidence. A second at least one word in the first utterance is recognized with less-than-high confidence. A content library is searched for a plurality of items that contain the first at least one word recognized with high confidence. One or more topics, including a first topic, is determined based on the plurality of items. One or more sub-topics associated with the first topic is determined based on the second at least one word recognized with less-than-high confidence. The first topic and the one or more sub-topics are displayed to the user.

### FIELD OF THE DISCLOSURE

The present disclosure is generally related to multimedia content and to voice search engines.

### BACKGROUND

There is an interest in providing on-demand access to multimedia content, such as Video-on-Demand (VoD) titles, to handheld devices and display devices, such as an internet protocol (IP) television, over either a wired or a wireless network. A user may key a search phrase into his/her handheld device or type into a wireless keyboard to attempt to find on-demand content of interest. Keying the search phrase into the device may comprise using hard buttons and/or soft buttons (e.g. when the device has a touch-sensitive screen). Attempting to key a long search phrase into the device may be cumbersome and error-prone.

Based on the search phrase, an online multimedia library is searched and one or more search results are returned and displayed on the user's device. However, many handheld devices have either a small display screen or no display screen at all, which limits the number of search results that can be displayed. This may make the search task impractical when the search space library has more than a few hundred streamed Internet Protocol Television (IP-TV) channels over a broadband network or more than a few thousand video clips downloadable from a 3G mobile service provider's network.

For example, to search a past episode of a pay-per-view TV program, a user can begin the search by keying a short query such as “TNT Law and Order” on a multifunction remote control with built-in alphanumeric push buttons. An intermediate search result comprising many titles of Law and Order episodes may be displayed on the display screen based on the query. The user either selects a particular episode from the display screen or keys additional search information to attempt to find the particular episode.

Recently, smart telephones and wireless-enabled personal digital assistants (PDAs) have embedded handwriting recognition technology to recognize users' handwritten search requests made to a touch-sensitive screen. However, the throughput of handwriting-based searches may be slow and the tasks may be tedious. In contrast to typing 40 to 60 words per minute on a normal-size computer keyboard, many users cannot handwrite on a smart phone or a PDA at a rate that exceeds 20 words per minute.

Thus, typing a long search query on a tiny keyboard built into a handheld device creates a significant user interface barrier for on-demand access. Similarly, screen-by-screen scrolling on a small display device creates a user interface barrier when searching a large library.

Accordingly, there is a need for an improved method and system of communicating to select multimedia content.

### BRIEF DESCRIPTION OF THE DRAWINGS

FIG. 1 is an example of a screen layout displayed to a user in response to an utterance;

FIG. 2 is a flow chart of an embodiment of a method of performing a voice search; and

FIG. 3 is a block diagram of an embodiment of a system for performing a voice search.

### DETAILD DESCRIPTION OF THE DRAWINGS

Embodiments of the present invention provide a domain-specific voice search engine capable of accepting natural and unconstrained speech as an input. A user can launch a complex search by simply speaking a search request such as “I would like to watch Peter Jennings' interview with Bill Gates last Friday”. But unlike voice search engines that are dependent on traditional word-by-word dictation, the domain-specific voice search engine does not require a word-by-word correction of a transcription of an utterance. Instead, the domain-specific voice search engine searches a domain-specific multimedia library for items that contain words from the utterance that are recognized with high confidence. One or more visual tags associated with content titles found in this search are presented to the user. For example, out of the thirteen words spoken in the above example, consider the phrase “Peter Jennings” as being recognized with high confidence. This name phrase is then used to search all text descriptions of multimedia titles in an IP-TV library.

If multiple matches are found, a topic such as a content tag most common to the matching titles is displayed as an intermediate guidepost. In the above example, consider the content tag most common to the matching titles being “World News Tonight with Peter Jennings”. One or more sub-topics are displayed along with the intermediate guidepost. The sub-topics lead the user either to select one such sub-topic for a system-led search path or to speak a new phrase to refine his/her existing search. The sub-topics presented at any given search step automatically cause the voice search engine to focus on those words most likely to be spoken next in light of the current guidepost.

The sub-topics are determined based on words from the utterance that are recognized with less-than-high confidence. In some embodiments, the sub-topics are determined based on words from the utterance that are recognized with medium confidence, but not based on words recognized with low confidence. For example, consider the utterance of “Bill Gates” as generating a plurality of medium-confidence recognition results, the N-best of which including “Bill Gates”, “Phil Cats” and “drill gas”. Presenting the N-best of these search results to the user would take too much valuable screen space. Instead, the voice search engine divides this set of N recognition results into a smaller number of M classes where all recognition results within a class share the same domain-specific semantic type. For example, N may be greater than or equal to a thousand, and M may be less than or equal to ten in some applications. For a news domain, the semantic types may include business, government, sports, technology and world, for example. These M classes of semantic types are displayed as context-specific sub-topics associated with each intermediate guidepost to promote a further search dialog between the user and the voice search engine.

Further, embodiments of the present invention automatically generate word probabilities for voice search engines configured for specific domains such as broadband-based video-on-demand programming provided to subscribers from an IP-TV service provider. The word probabilities used by the voice search engine are predicatively modified in real time after each dialog within the same search session. In particular, the voice search engine is tuned to a smaller set of words most likely to be spoken in the next dialog as predicted by the search scope at that point in time. This reduces the size of the intermediate search results presented to the user after each subsequent dialog in the same search session.

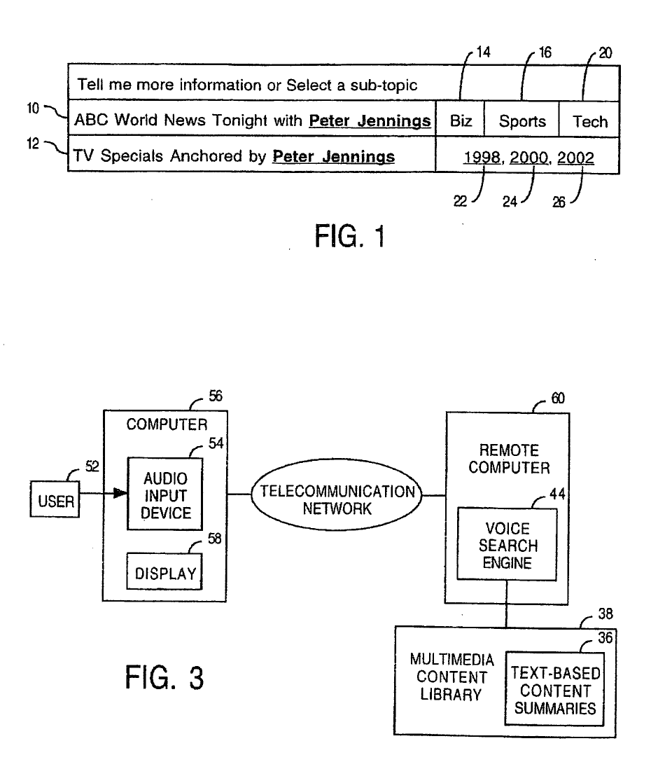

FIG. 1 shows an example of a screen layout displayed to the user in response to the above example utterance. The screen layout includes two guideposts, a first guidepost 10 of “ABC World News Tonight with Peter Jennings” and a second guidepost 12 of “TV Specials anchored by Peter Jennings”. The name phrase “Peter Jennings” is underlined and in bold (or may be otherwise highlighted) to indicate to the user that the name phrase “Peter Jennings” was recognized with high confidence. Displayed along with the guideposts 10 and 12 are their corresponding sub-topics. Corresponding to the first guidepost 10 is a first sub-topic 14 of “biz” for business, a second sub-topic 16 of “sports” and a third sub-topic 20 of “tech” for technology. Corresponding to the second guidepost 12 is a first sub-topic 22 of “1998”, a second sub-topic 24 of “2000” and a third sub-topic 26 of “2002”.

With the topics and sub-topics suggested by the voice search engine, the user may remember that the interview with Bill Gates mentioned speech recognition technology at Microsoft. At this point, the user may simply speak a second search utterance such as “it is about speech recognition technology”. Because the sub-topic 20 of “tech” has cause the voice search engine to raise the probability for all the technology-related words visible to the guidepost 10 of “ABC World News Tonight with Peter Jennings”, the spoken words in the second search utterance have a higher probability of being recognized with high confidence. In this case, the voice search engine will scan the content library for summaries of all recent episodes of ABC World News Tonight that contain “Peter Jennings” and “speech recognition”. If only one such episode is found in the 2005 catalog of the library, the search is completed successfully.

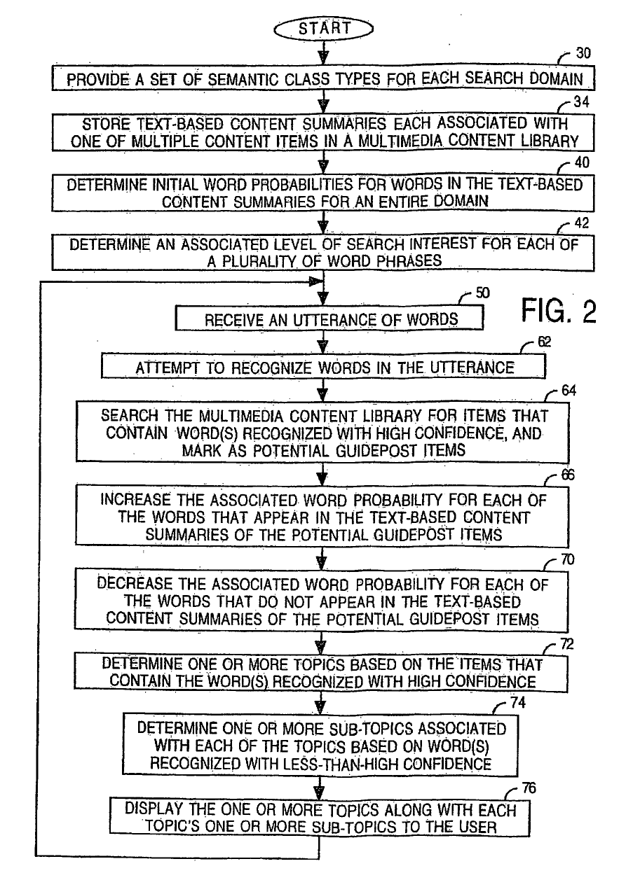

FIG. 2 is a flow chart of an embodiment of a method of performing a voice search, and FIG. 3 is a block diagram of a system for performing the voice search. As indicated by block 30, the method comprises providing a set of semantic class types for each search domain. For example, a search domain such as “music video” may contain semantic class types such as artist, album, genre, song name and lyrics.

As indicated by block 34, the method comprises storing text-based content summaries 36 each associated with one of multiple content items in a multimedia content library 38. The multiple content items may comprise a plurality of audio content items (e.g. recorded songs), a plurality of video content items (e.g. movies, television programs, music videos), and/or a plurality of textual content items. The text-based content summaries 36 contain important words to assist in finding user-desired content. The words in the text-based content summaries 36 may be associated with particular tags. For each song, for example, the text-based content summary may comprise a name of the song with its tag (e.g. “song name”), a name of an artist such one or more singers who performed the song with its tag (e.g. “artists”), and the entire lyrics of the song. Also stored is a unique index associated with each of the multiple content items.

As indicated by block 40, the method comprises determining initial word probabilities for words in the text-based content summaries for an entire domain. This act may include determining an associated word probability, for each of a plurality of words, based on a frequency of occurrence of the word in the text-based content summaries for the domain.

In some embodiments, all titles in a domain-specific multimedia content library are pre-sorted into a plurality of common categories. Examples of the categories include, but are not limited to, “classic”, “family”, “romance”, “action” and “comedy”. Based on a customer profile obtained during an initial sign-on (or prior to the very first use) by a new customer, a number of categories are assigned to the new customer. All of the titles in those matching categories are marked as “potential interest”. The initial word probabilities can be generated based on the frequency of occurrence only in those items marked as being of “potential interest”.

Optionally, a customer can create multiple profiles for different users in the customer's environment. Examples of the profiles include, but are not limited to, “parents”, “teens” and “adult-17-or-older”. Upon a first login by each user within a customer's household, different word probabilities may be used for his/her initial use. Over time, the word probabilities can be automatically adjusted for each recognized user based on the types of multimedia content titles he/she has viewed and the history of his/her past voice search requests.

Either in addition to or as an alternative to customer-specific user profiles, those items in the multimedia content library 38 that are most requested over a given time period can be tracked. For example, the movie “It's a Wonderful Life” can be assigned a high ranking score for Christmas season (e.g. from November 25 to December 31) based on its being heavily requested during this time period. During this time period, for all new or relatively new users, the word probabilities for all key words in the content summary for this movie title are increased based on its high ranking score. For each user who has established a long history from his/her past usage, the word probabilities for all items of “potential interest” to him/her are adjusted after each usage.

As indicated by block 42, the method comprises determining an associated level of search interest for each of a plurality of word phrases. This act may comprise determining a level of search interest for a word phrase based on a number of search results found for the word phrase in a specific domain. The word phrases may comprise names of people and/or names of places which, in certain domains, assist in performing an efficient search.

In one embodiment, all word phrases tagged as “people” or “place” are further ranked by their interest level for a given user community. The user community may be a large as the World Wide Web (WWW). The level of interest within the WWW community can be calculated by counting how many Web pages contain a name phrase (for people or for places). For example, a common Web search engine may return 500 results related to the domain “music” for the name “Richard Mark”, and may return 150,000 results related to the same domain for the name “Richard Marx”. Levels of search interest in the domain are stored based on the number of search results found by the Web search engine. The level of search interest may be based on a logarithm of the number of search results, e.g. a base-two logarithm of the number of search results. In one embodiment, the integer closest to the base-two logarithm of the number of search results is stored as the level of search interest. For example, the rank for “Richard Mark” within the music domain is 9 (because 2 to the 9^{th} power is 512 which is closest to 500) and the rank for “Richard Marx” within the music domain is 17 (because 2 to the 17^{th} power is 131,072 which is closest to 150,000).

The domain-specific rank system can be used to further determine which name should be used to narrow down an internal search if two similar sounding names are proposed by a voice search engine 44 as a potential match to a phrase such as a two-word block.

As indicated by block 50, the method comprises receiving a first utterance of words. The first utterance is spoken by a user 52 into an audio input device 54 such as a microphone or an alternative transducer. The audio input device 54 is either integrated with or in communication with a computer 56 having a display 58. The computer 56 may be embodied by a wireless or wireline telecommunication device and may be handheld. Examples of the computer 56 include, but are not limited to, a mobile telephone such as a smart phone or a PDA phone, a personal computer, or a set-top box (in which case the display 58 may comprise a television screen). The first utterance may be communicated via a telecommunication network to a remote computer 60, which receives the utterance for subsequent processing by the voice search engine 44.

The voice search engine 44 allows the user 52 to speak a search request in a natural mode of input such as everyday unconstrained speech. Natural-speech-driven search is efficient since adults may speak at an average rate of roughly 120 words per minute, which is six times faster than typing on a PDA or a smart phone with a touch-sensitive screen.

As indicated by block 62, the method comprises the voice search engine 44 attempting to recognize words in the utterance. The voice search engine 44 may recognize a first at least one word with high confidence and a second at least one word with less-than-high confidence such as medium confidence. Other word or words may be unrecognized.

As indicated by block 64, the method comprises searching the multimedia content library 38 for items that contain the first at least one word recognized with high confidence. This act may comprise searching the text-based content summaries 36 for those items that have the first at least one word recognized with high confidence. Each item (e.g. each content title) found in the search is marked as a potential guidepost item.

As indicated by blocks 66 and 70, the method comprises modifying the word probabilities based on those items marked as potential guidepost items. Block 66 indicates an act of increasing the associated word probability for each of the words that appear in the text-based content summaries of the potential guidepost items (e.g. those items that contain the first at least one word recognized with high confidence). This act may comprise increasing the associated word probability of a word by a delta value proportional to a frequency of occurrence of the word in the text-based summaries of the set of potential guidepost items. Block 70 indicates an act of decreasing the associated word probability for each of the words that do not appear in the text-based content summaries of the potential guidepost items. This act may comprise decreasing, by half, the associated word probability for each of the words that do not appear in the text-based content summaries of the potential guidepost items. Decreasing the word probability makes these words less visible under the current guidepost items.

As indicated by block 72, the method comprises determining one or more topics based on the items that contain the first at least one word recognized with high confidence. The topics are based on those items marked as potential guidepost items. The number of guidepost items may be reduced by keeping only a top N of the guidepost items ranked based on at least one word phrase contained therein and its associated level of search interest. The number N may be selected based on the number of items that can fit on the display 58 (e.g. based on the number of lines of text that will fit on the display 58).

As indicated by block 74, the method comprises determining one or more sub-topics associated with each of at least one of the topics (e.g. the top N guidepost items) based on the second at least one word recognized with less-than-high confidence (e.g. medium confidence). For a particular topic or guidepost item, this act may comprise determining one or more semantic classes tagged to the second at least one word recognized with less-than-high confidence (e.g. medium confidence), and sorting the semantic classes in a domain-specific order. For example, for the domain “music”, the tag “artists” may have a higher rank than the tag “song name” because people may remember the name of a singer better than a name of the song they are looking for. The top-tier semantic classes for the guidepost item are used as the sub-topics for the guidepost item.

As indicated by block 76, the method comprises displaying, to the user 52, the one or more topics along with each topic's one or more sub-topics on the display 58. Thus, the top-tier semantic classes are displayed as sub-topics along with their main guidepost item. The voice search engine 44 may output a signal that includes the aforementioned information to be displayed. This signal is communicated from the remote computer 60 to the computer 56. The displayed sub-topics are user-selectable (e.g. using a touch screen, a keyboard, a key pad, one or more buttons, or a pointing device) so that the user 52 can better focus his/her search. The sub-topics lead the user 52 either to select one such sub-topic for a system-led search path or to speak a new phrase to refine his/her existing search. This process can be repeated until a desired title is found from the multimedia content library 38. The desired title may be served to the user 52 and the user 52 may be billed if the desired title is pay-per-view or pay-per-download.

In this way, the voice search engine 44 presents visual predictors associated with intermediate search results so that the user 52 will intuitively choose different words or phrases to narrow his/her search in each iteration.

Flow of the method may return to block 50, wherein a subsequent utterance of words spoken by the user 52 is received. Referring back to block 62, the voice search engine 44 attempts to recognize words in the subsequent utterance. However, since the word probabilities have been modified in blocks 66 and 70, the overall recognition vocabulary has been effectively reduced exponentially. Thus, many words will not be visible for a potential match when processing the subsequent utterance under the reduced search scope. Further, at least one word in the subsequent utterance may be recognized based on its associated word probability having been increased in block 66. In this way, multiple search utterances recognized by the voice search engine 44 within the same search session can be sorted and then submitted to the multimedia content library 38 for a possible match to one or more titles therein.

The herein-described acts performed by the computer 56 may be performed by one or more computer processors directed by computer-readable program code stored by a computer-readable medium. The herein-described acts performed by the remote computer 60 may be performed by one or more computer processors directed by computer-readable program code stored by a computer-readable medium. The text-based content summaries 36 and the multimedia content library 38 can be stored as computer-readable data in data structure(s) by one or more computer-readable media.

The herein-disclosed method and system are well suited for use with a VoD service (e.g. a broadband-based IP-TV service, a cable TV service or a satellite TV service) that can provide any of tens of thousands or more VoD titles, or a 3G mobile media service that can provide any of hundreds of thousands of video clips in a variety of domains.

In contrast to desktop-based Web search engine technology, the voice search engine 44 offers the following distinct advantages when deployed in a network environment for accessing a large-scale multimedia content library from a small handheld device.

1. A large screen to display 40 to 60 pieces of text-oriented search results is not required. Instead, a large body of intermediate search results may be transformed into a small number of guideposts (e.g. 5 to 10 guideposts) that are most likely pointing to a subsequent search path leading to a multimedia content title that the user is looking for.

2. Word-level editing based on user-detected speech recognition errors is not required by the voice search engine. Transcription errors are inevitable for speech recognition of a naturally spoken but complex search utterance, especially when searching a large multimedia content library having 100,000 unique words.

3. Word and/or phrase probabilities used to recognize a search utterance are dynamically modified according to a current search scope. This acts to exponentially reduce the search scope at each step, and reduce the number of words visible to the voice search engine as a potential candidate for recognition at the next dialog.

4. The reduction of the active recognition vocabulary at each search iteration is performed using a domain-specific ranking system that determines which subset of the content titles stored in the library is most likely of interest to the user in a given search context.

5. A dialog context is constructed from words recognized with high confidence from multiple search utterances within a search session. The voice search engine can exponentially reduce the search scope using the dialog history.

6. For each successful search, the content summary for the final content title found in the library can be modified to include a shortcut (e.g. “[Peter Jennings]”, “[Bill Gates]” or “[speech recognition]” for the example of FIG. 1). Over time, the shortcuts accumulate based on usage patterns of a large number of users. The accumulated shortcuts enable the voice search engine to improve its recognition performance by giving more weight to certain word pairs or phrases in certain domain-specific contexts.

It will be apparent to those skilled in the art that the disclosed embodiments may be modified in numerous ways and may assume many embodiments other than the particular forms specifically set out and described herein. For example, some of the acts described with reference to FIG. 2 can be performed either in an alternative order or in parallel.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving a first utterance of words;
recognizing a first at least one word in the first utterance with high confidence;
recognizing a second at least one word in the first utterance with less-than-high confidence;
searching a content library for a plurality of items that contain the first at least one word recognized with high confidence;
determining one or more topics, including a first topic, based on the plurality of items that contain the first at least one word recognized with high confidence;
determining one or more sub-topics associated with the first topic based on the second at least one word recognized with less-than-high confidence; and
displaying the first topic and the one or more sub-topics.

2. The method of claim 1, further comprising:
storing, in the content library, an associated text-based content summary for each of multiple items;
wherein said searching the content library comprises searching the text-based content summaries.

3. The method of claim 2, wherein the multiple items comprise a plurality of songs, and wherein the associated text-based content summary for each of the songs includes a name of the song, an artist who performed the song, and lyrics of the song.

4. The method of claim 2, further comprising:
for each of a plurality of words, determining an associated word probability based on a frequency of occurrence of the word in the text-based content summaries; and
increasing the associated word probability for each of the words that appear in the text-based content summaries of the plurality of items that contain the first at least one word recognized with high confidence.

5. The method of claim 4, wherein said increasing comprises increasing the associated word probability for a word by a value proportional to a frequency of occurrence of the word in the text-based content summaries of the plurality of items.

6. The method of claim 4, further comprising:
decreasing the associated word probability for each of the words that do not appear in the text-based content summaries of the plurality of items that contain the first at least one word recognized with high confidence.

7. The method of claim 6, wherein said decreasing comprises decreasing, by half, the associated word probability of a word that does not appear in the text-based content summaries of the plurality of items that contain the first at least one word recognized with high confidence.

8. The method of claim 4, further comprising:
receiving a second utterance of words; and
recognizing a third at least one word in the second utterance based on its associated word probability having been increased.

9. The method of claim 1, further comprising:
determining an associated level of search interest for each of a plurality of word phrases.

10. The method of claim 9, wherein said determining the associated level of search interest comprises determining a level of search interest for a word phrase based on a number of search results found for the word phrase in a specific domain.

11. The method of claim 10, wherein the specific domain is a domain of the World Wide Web.

12. The method of claim 9, wherein said determining the one or more topics comprises:
determining a top N of the plurality of items based on at least one word phrase contained therein and its associated level of search interest.

13. The method of claim 1, wherein said determining one or more sub-topics associated with the first topic comprises determining one or more semantic classes tagged to the second at least one word recognized with less-than-high confidence.

14. The method of claim 13, further comprising:
sorting the one or more semantic classes in a domain-specific order.

15. The method of claim 1, wherein the less-than-high confidence is a medium confidence.

16. A computer-readable medium having computer-readable program code to cause a computer system to:
receive a first utterance of words;
recognize a first at least one word in the first utterance with high confidence;
recognize a second at least one word in the first utterance with less-than-high confidence;
search a content library for a plurality of items that contain the first at least one word recognized with high confidence;
determine one or more topics, including a first topic, based on the plurality of items that contain the first at least one word recognized with high confidence;
determine one or more sub-topics associated with the first topic based on the second at least one word recognized with less-than-high confidence; and
display the first topic and the one or more sub-topics.

17. The computer-readable medium of claim 16, wherein the computer-readable program code is to cause the computer system further to:
store, in the content library, an associated text-based content summary for each of multiple items;
wherein the content library is searched by searching the text-based content summaries.

18. The computer-readable medium of claim 17, wherein the multiple items comprise a plurality of songs, and wherein the associated text-based content summary for each of the songs includes a name of the song, an artist who performed the song, and lyrics of the song.

19. The computer-readable medium of claim 17, wherein the computer-readable program code is to cause the computer system further to:
for each of a plurality of words, determine an associated word probability based on a frequency of occurrence of the word in the text-based content summaries; and
increase the associated word probability for each of the words that appear in the text-based content summaries of the plurality of items that contain the first at least one word recognized with high confidence.

20. The computer-readable medium of claim 19, wherein the associated word probability for a word is increased by a value proportional to a frequency of occurrence of the word in the text-based content summaries of the plurality of items.

21. The computer-readable medium of claim 19, wherein the computer-readable program code is to cause the computer system further to:
decrease the associated word probability for each of the words that do not appear in the text-based content summaries of the plurality of items that contain the first at least one word recognized with high confidence.

22. The computer-readable medium of claim 21, wherein the associated word probability of a word that does not appear in the text-based content summaries of the plurality of items that contain the first at least one word recognized with high confidence is decreased by half.

23. The computer-readable medium of claim 19, wherein the computer-readable program code is to cause the computer system further to:
receive a second utterance of words; and
recognize a third at least one word in the second utterance based on its associated word probability having been increased.

24. The computer-readable medium of claim 16, wherein the computer-readable program code is to cause the computer system further to:
determining an associated level of search interest for each of a plurality of word phrases.

25. The computer-readable medium of claim 24, wherein the associated level of search interest is determined by determining a level of search interest for a word phrase based on a number of search results found for the word phrase in a specific domain.

26. The computer-readable medium of claim 25, wherein the specific domain is a domain of the World Wide Web.

27. The computer-readable medium of claim 24, wherein the one or more topics are determined by determining a top N of the plurality of items based on at least one word phrase contained therein and its associated level of search interest.

28. The computer-readable medium of claim 16, wherein the one or more sub-topics associated with the first topic are determined by determining one or more semantic classes tagged to the second at least one word recognized with less-than-high confidence.

29. The computer-readable medium of claim 28, wherein the computer-readable program code is to cause the computer system further to:
sort the one or more semantic classes in a domain-specific order.

30. The computer-readable medium of claim 16, wherein the less-than-high confidence is a medium confidence.
